(19) United States
(12) Patent Application Publication
(10) Pub. No.: US 2025/0298563 A1
(43) Pub. Date: Sep. 25, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Akira KADODA, Kanagawa (JP)

(73) Assignee: FUJIFILM Business Innovation Corp., Tokyo (JP)

(21) Appl. No.: 18/774,474

(22) Filed: Jul. 16, 2024

(30) Foreign Application Priority Data
Mar. 22, 2024 (JP) 2024-046103

(51) Int. Cl. G06F 3/12

(52) U.S. Cl. CPC G06F 3/1259; G06F 3/1207; G06F 3/1289

(57) ABSTRACT

An information processing system includes one or more processors configured to: monitor a shared area within the information processing system that is shared between the information processing system and an other information processing system remotely operated by the information processing system; and in a case where registration information indicating that the other information processing system has registered data in a server is stored in the shared area, start monitoring whether or not the data has been registered in the server.

### CROSS-REFERENCE TO RELATED APPLICATIONS

This application is based on and claims priority under 35 USC 119 from Japanese Patent Application No. 2024-046103 filed Mar. 22, 2024.

### BACKGROUND

### (i) Technical Field

The present disclosure relates to an information processing system and a non-transitory computer readable medium.

### (ii) Related Art

Japanese Unexamined Patent Application Publication No. 2018-34375 describes a printing system in which a cloud print service notifies a multifunction apparatus of an event indicating that a print job has been accepted from a client PC, and upon acceptance of the event, the multifunction apparatus stores the event in a unique queue, and notifies the cloud print service that print processing will be performed on the print job to stop notification of the event and, when the preceding print job is already under print processing, notifies the cloud print service to stop notification of the event for the print job stored in the unique queue.

Japanese Unexamined Patent Application Publication No. 2012-164171 describes an image processing system in which a printer transfers a print job received from a host computer to a cloud server, requests an end time of processing of the print job in the cloud server to the cloud server, receives the end time returned from the cloud server, shifts the printer to a sleep state for the end time, requests processed data of the print job to the cloud server after the end time has elapsed and the printer returns from the sleep state, receives the processed data returned from the cloud server, and performs print processing of the processed data.

### SUMMARY

When a second information processing system remotely operated by a first information processing system instructs a server to register data, the first information processing system does not know that the second information processing system has instructed the server to register the data. Therefore, it is not efficient for the first information processing system to constantly monitor whether or not the data has been registered to the server.

Aspects of non-limiting embodiments of the present disclosure relate to allowing the first information processing system to efficiently confirm whether or not the data has been registered in the server, when the second information processing system remotely operated by the first information processing system instructs the server to register the data.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or more processors configured to: monitor a shared area within the information processing system that is shared between the information processing system and an other information processing system remotely operated by the information processing system; and in a case where registration information indicating that the other information processing system has registered data in a server is stored in the shared area, start monitoring whether or not the data has been registered in the server.

### BRIEF DESCRIPTION OF THE DRAWINGS

Exemplary embodiment of the present disclosure will be described in detail based on the following figures, wherein:

FIG. 1 is a diagram illustrating an example of an overall configuration of a printing system according to the present exemplary embodiment;

FIG. 2 is a diagram illustrating an example of a hardware configuration of an information processing apparatus according to the present exemplary embodiment;

FIG. 3 is a diagram illustrating an example of a hardware configuration of a printer according to the present exemplary embodiment;

FIG. 4 is a diagram illustrating an outline of processing when processing is normally performed in the printing system according to the present exemplary embodiment;

FIG. 5 is a diagram illustrating an outline of processing when an error occurs in the printing system according to the present exemplary embodiment;

FIG. 6 is a block diagram illustrating an example of a functional configuration of a first information processing apparatus according to the present exemplary embodiment;

FIG. 7 is a block diagram illustrating an example of a functional configuration of a second information processing apparatus according to the present exemplary embodiment;

FIG. 8 is a flowchart illustrating an operation example of the second information processing apparatus according to the present exemplary embodiment; and

FIG. 9 is a flowchart illustrating an operation example of the first information processing apparatus according to the present exemplary embodiment.

### DETAILED DESCRIPTION

In the following, an exemplary embodiment of the disclosure will be described in detail with reference to the accompanying drawings.

### Outline of the Present Exemplary Embodiment

The present exemplary embodiment provides a first information processing system that monitors a shared area within an information processing system that is shared between the information processing system and another information processing system remotely operated by the information processing system, and in a case where registration information indicating that the other information processing system has registered data in a server is stored in the shared area, starts monitoring whether or not the data has been registered in the server.

In addition, the present exemplary embodiment also provides a second information processing system that monitors a shared area in another information processing system that is shared between the information processing system and the other information processing system remotely operating the information processing system, and detects a result of monitoring as to whether or not data has been registered in a server, the monitoring being started by the other information processing system in a case where registration information indicating that the information processing system has registered the data in the server is stored in the shared area.

Here, the “system” may be configured by a single apparatus, or may be configured by a plurality of apparatuses. In the following description, the first information processing system constituted by a single apparatus is taken as an example, and as the single apparatus, a first information processing apparatus will be described as an example. In addition, as the second information processing system constituted by a single apparatus is taken as an example, and as the single apparatus, a second information processing apparatus will be described as an example.

Further, although a remote operation may be performed by any techniques, a case where the remote operation is performed by a remote desktop will be described below as an example. Here, the remote desktop is a technique in which an information processing apparatus at a remote site is accessed via a communication network and is operated by the information processing apparatus at hand.

Although the shared area may be any storage area that is shared between the first information processing apparatus and the second information processing apparatus, a shared folder will be described below as an example.

Further, although the data may be any data, print data will be described below as an example.

Furthermore, the server may be any server, but a cloud server will be described below as an example.

### Overall Configuration of Printing System

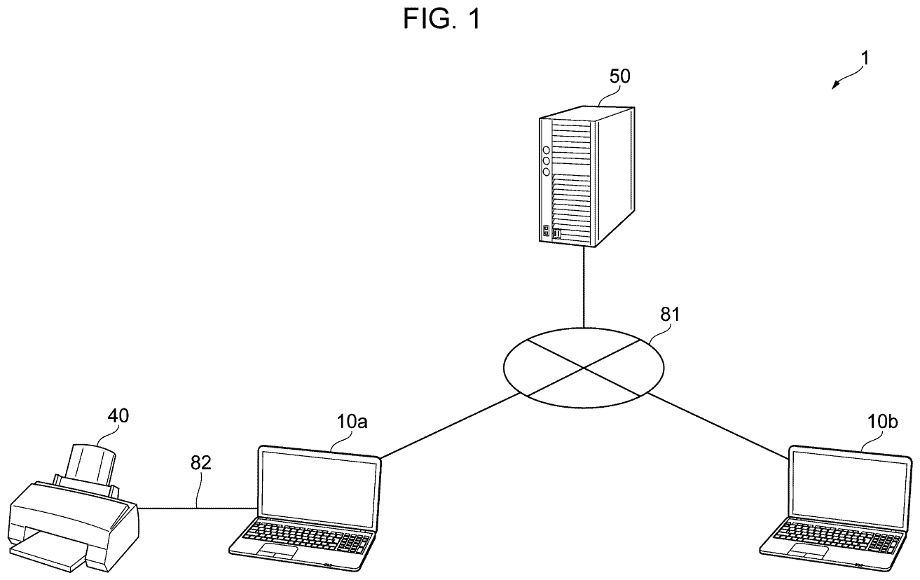

FIG. 1 is a diagram illustrating an example of an overall configuration of a printing system 1 according to the present exemplary embodiment. As illustrated in the figure, the printing system 1 includes a first information processing apparatus 10a, a second information processing apparatus 10b, a printer 40, and a cloud server 50. The first information processing apparatus 10a and the second information processing apparatus 10b are connected to the cloud server 50 via a communication network 81, and the printer 40 is connected to the first information processing apparatus 10a via a communication network 82. Note that, although the first information processing apparatus 10a and the second information processing apparatus 10b are illustrated in the figure, when it is not necessary to distinguish the first information processing apparatus 10a and the second information processing apparatus 10b from each other, the first information processing apparatus 10a and the second information processing apparatus 10b may be collectively referred to as an information processing apparatus 10.

The first information processing apparatus 10a and the second information processing apparatus 10b are computers used by users. It is assumed that the first information processing apparatus 10a is an information processing apparatus that is installed, for example, at home and serves as a connection source of the remote desktop. In addition, it is assumed that the second information processing apparatus 10b is, for example, an information processing apparatus that is installed in a company and to which a remote desktop is connected. For example, in the first information processing apparatus 10a, the user creates a document to be printed while displaying a screen of the second information processing apparatus 10b, and registers the print data that includes the document to be printed and print parameters to the cloud server 50. In the first information processing apparatus 10a, the user downloads the print data from the cloud server 50, and instructs the printer 40 to perform printing based on the print data. As the first information processing apparatus 10a and the second information processing apparatus 10b, for example, desktop PCs, notebook PCs, portable information terminals, and the like may be used. Note that, although only one first information processing apparatus 10a and one second information processing apparatus 10b are illustrated in the figure, a plurality of first information processing apparatuses 10a and a plurality of second information processing apparatuses 10b may be provided. In the present exemplary embodiment, in a case where the first information processing apparatus 10a is provided as an example of the information processing system and the information processing system, the second information processing apparatus 10b is provided as an example of another information processing system remotely operated by the information processing system. In addition, in the present exemplary embodiment, in a case where the second information processing apparatus 10b is provided as an example of the information processing system and the information processing system, the first information processing apparatus 10a is provided as an example of another information processing system remotely operates the information processing system.

The printer 40 is an apparatus that prints information on a recording medium such as paper. The printer 40 is installed at home, for example, and performs printing based on the print data in response to a print instruction from the first information processing apparatus 10a. Note that, in the figure, only one printer 40 is illustrated, but a plurality of the printers 40 may be provided.

The cloud server 50 is a server computer that provides a cloud print service in which the print data registered from the second information processing apparatus 10b is saved and sent the print data to the first information processing apparatus 10a to enable printing by the printer 40. Note that, in the figure, although only one cloud server 50 is illustrated, a plurality of the cloud servers 50 may be provided. Further, a normal server computer may be used instead of the cloud server 50.

The communication network 81 is a line used for information communication between the first information processing apparatus 10a, the second information processing apparatus 10b, and the cloud server 50. As the communication network 81, for example, the Internet may be used.

The communication network 82 is a line used for information communication between the first information processing apparatus 10a and the printer 40. As the communication network 82, for example, a local area network (LAN) may be used.

### Hardware Configuration of Information Processing Apparatus

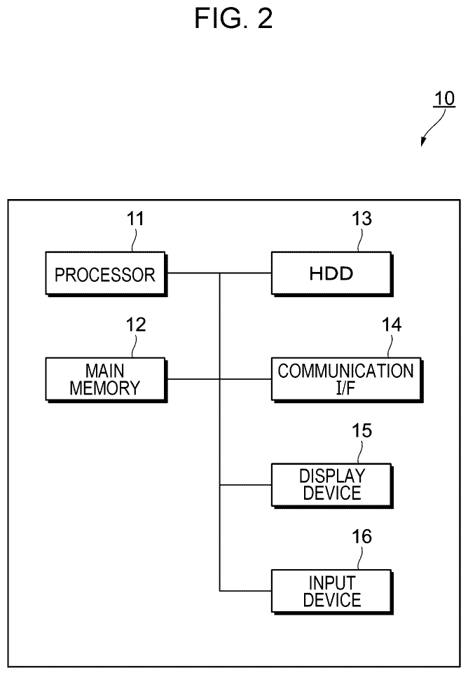

FIG. 2 is a diagram illustrating an example of a hardware configuration of the information processing apparatus 10 according to the present exemplary embodiment. As illustrated in the figure, the information processing apparatus 10 includes a processor 11, a main memory 12, a hard disk drive (HDD) 13, a communication interface (hereinafter, written as a “communication I/F”) 14, a display device 15, and an input device 16.

The processor 11 realizes each function described later by executing various kinds of software such as an operating system (OS) and an application.

The main memory 12 is a memory used as a working memory and the like of the processor 11.

The HDD 13 is, for example, a magnetic disk device that stores input data to various kinds of software, output data from various kinds of software, and the like.

The communication I/F 14 transmits and receives various kinds of information to and from another apparatus via the communication network. For example, in the first information processing apparatus 10a and the second information processing apparatus 10b, the communication I/F 14 transmits and receives various kinds of information to and from the cloud server 50 via the communication network 81. In addition to the above, the first information processing apparatus 10a transmits and receives various kinds of information to and from the printer 40 via the communication network 82.

The display device 15 is, for example, a display that displays various kinds of information.

The input device 16 is, for example, a keyboard or a mouse used by the user to input information.

The hardware configuration illustrated in FIG. 2 may also be regarded as the hardware configuration of the cloud server 50. However, when the cloud server 50 is described, the processor 11, the main memory 12, the HDD 13, the communication I/F 14, the display device 15, and the input devices 16 in FIG. 2 are referred to as a processor 51, a main memory 52, an HDD 53, a communication I/F 54, a display device 55, and an input device 56, respectively.

### Hardware Configuration of Printer

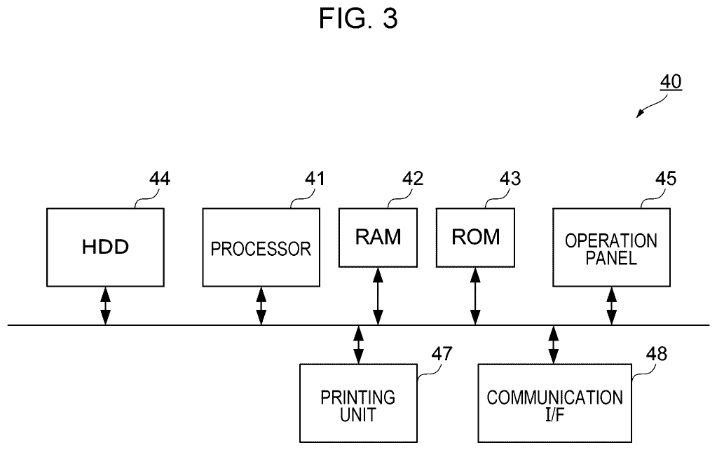

FIG. 3 is a diagram illustrating an example of a hardware configuration of the printer 40 according to the present exemplary embodiment. As illustrated in the figure, the printer 40 includes a processor 41, a random access memory (RAM) 42, a read only memory (ROM) 43, an HDD 44, an operation panel 45, a printing unit 47, and a communication I/F 48.

The processor 41 realizes each function which will be described later by loading various programs stored in the ROM 43 and the like into the RAM 42 and executing the programs.

The RAM 42 is a memory used as a working memory and the like of the processor 41.

The ROM 43 is a memory that stores various programs and the like to be executed by the processor 41.

The HDD 44 is, for example, a magnetic disk device which stores the print data and the like used in print processing in the printing unit 47.

The operation panel 45 is, for example, a touch panel that displays various kinds of information and accepts operation input from the user. Here, the operation panel 45 includes a display on which various kinds of information are displayed and a position detection sheet for detecting a position instructed by an instruction means, such as a finger or a stylus pen. Alternatively, the display and the keyboard may be used instead of the touch panel.

The printing unit 47 prints information on a recording medium such as paper. Here, the printing unit 47 is, for example, a printer, and it is preferable to use an electrophotographic method in which a toner adhered to a photoreceptor is transferred onto the recording medium to form an image, or an ink jet method in which ink is ejected onto the recording medium to form the image.

The communication I/F 48 transmits and receives various kinds of information to and from another apparatus via the communication network. For example, the communication I/F 48 transmits and receives various kinds of information to and from the first information processing apparatus 10a via the communication network 82.

### Problem and Solution of Printing System

In the printing system 1 as described above, the user registers the print data to the cloud print service of the cloud server 50 from the second information processing apparatus 10b. Then, the user uses a print agent (hereinafter, simply referred to as an “agent”), which is software operating in the first information processing apparatus 10a, to download the print data from the cloud server 50 and issue a print instruction based on the print data. Thus, the printer 40 performs printing based on the print data.

However, when the user needs to perform some operation on the agent, such as confirmation of the print data in the cloud server 50 or issuance of a print instruction to the printer 40, in order to perform printing by the printer 40, the following problem arises.

First, the user displays and works on the screen of the second information processing apparatus 10b as a remote desktop connection destination and registers the print data to the cloud server 50. Therefore, in order to issue a print instruction to the printer 40, it is necessary to switch to the screen of the first information processing apparatus 10a and operate the agent, which takes time and effort.

Secondly, the registration of the print data in the cloud server 50 may take time until completion. This is because, for example, uploading a large size file, performing image conversion processing, or the like takes time. Therefore, when the user confirms the registration of the print data, the registration of the print data is not completed in some cases, that is, at the time an inquiry is made by the agent. In such a case, confirmation needs to be done again after a while. In addition, when the cloud server 50 is continuously monitored as a countermeasure against such a situation, a communication load, a waste of resources, and the like are increased, which leads to an increase in cost.

Therefore, in the present exemplary embodiment, when an agent operating in the first information processing apparatus 10a performs a remote desktop connection, the agent shares a specific folder of the first information processing apparatus 10a with the second information processing apparatus 10b and monitors the specific folder. When a print information file is stored in the specific folder, a driver for cloud printing (hereinafter, simply referred to as a “driver”) that operates in the second information processing apparatus 10b starts monitoring the specific folder. Note that folder sharing may be performed by using an existing technique related to the remote desktop connection.

### Outline of Processing of Printing System

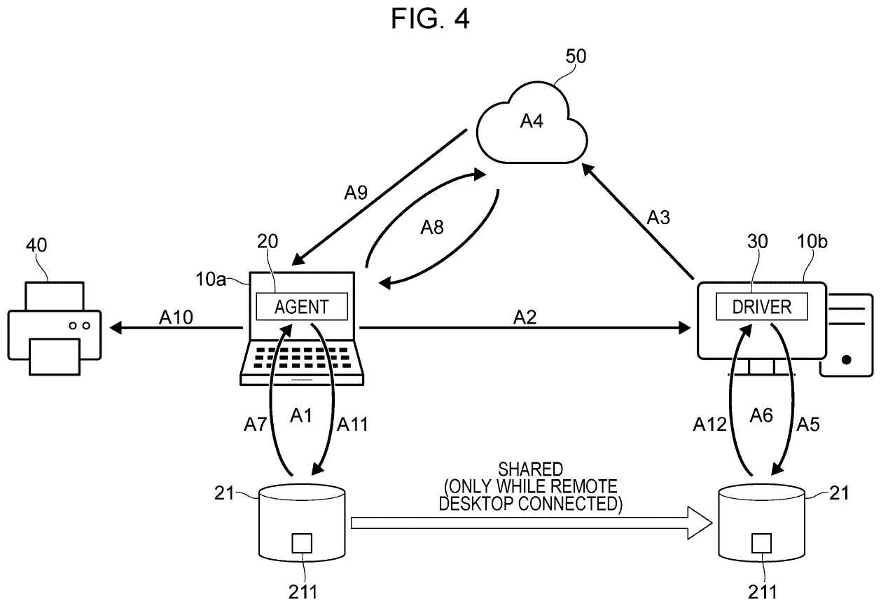

FIG. 4 is a diagram illustrating an outline of processing in a case where processing is normally performed in the printing system 1 according to the present exemplary embodiment.

As illustrated in the figure, when the user starts the first information processing apparatus 10a and logs in, an agent 20 starts monitoring the specific folder in the first information processing apparatus 10a (A1). Here, the specific folder may be a folder that is created when the agent 20 is installed in the first information processing apparatus 10a and which depends on the user. For example, a path of the specific folder may be “C: \Users\ (user name) \Documents\PrintAgent\Temp”, and change of the path may be set not allowed to the user. Note that, for the agent 20, the cost of monitoring the folder in the first information processing apparatus 10a is lower than the cost of monitoring the cloud server 50.

Next, the user performs the remote desktop connection from the first information processing apparatus 10a to the second information processing apparatus 10b (A2). At that time, the user specifies, as a connection option, a setting for sharing the specific folder of the first information processing apparatus 10a, and performs the remote desktop connection. Hereinafter, the specific folder set to be shared in this manner is referred to as a “shared folder 21”. Further, even before the sharing setting is made, the specific folder for which the sharing setting is to be made may be referred to as the “shared folder 21” for convenience.

In this state, a driver 30 registers the print data to the cloud server 50 (A3).

With this, the cloud server 50 performs print data registration processing in the cloud print service (A4). Here, the registration processing includes, for example, image conversion of the print data, and the like.

When the print data is registered to the cloud server 50 in this manner, the driver 30 copies a print information file 211 to the shared folder 21 (A5).

Specifically, first, the driver 30 confirms whether or not the second information processing apparatus 10b is connected by the remote desktop.

As a result, when the second information processing apparatus 10b is connected by the remote desktop, the driver 30 acquires a PC name and the user name of the connection source by using the existing technique. When the PC name and the user name of the connection source are acquired, the driver 30 determines a path of the shared folder 21. For example, the driver 30 may determine “\\ (PC name) \Users\ (user name) \Documents\PrintAgent\Temp” as the path of the shared folder 21. Thereafter, the driver 30 copies the print information file 211 to the shared folder 21 of this path. Note that, it is assumed that the driver 30 which can cooperate with the agent 20 knows a portion “\Documents\PrintAgent\Temp”.

On the other hand, when the second information processing apparatus 10b is not connected by the remote desktop, the driver 30 does not copy the print information file 211.

Here, the print information file 211 may be any file as long as the print data can be uniquely specified. For example, the print information file 211 may specify the print data only by the name of the file to be printed. The print information file 211 may be empty as long as the print data can be specified.

Thereafter, the driver 30 monitors the shared folder 21 until the print information file 211 is deleted by the agent 20 (A6).

On the other hand, the agent 20 detects that the print information file 211 is stored in the shared folder 21 in monitoring (A7). Then, the agent 20 starts monitoring the cloud server 50 at a predetermined interval (A8). That is, the agent 20 inquires of the cloud server 50 whether or not the print data specified by the print information file 211 is registered.

Thus, when the print data has been registered to the cloud server 50, the agent 20 downloads the print data (A9). Note that when the print data is canceled in the cloud server 50, the agent 20 acquires that event and deletes the print information file 211 from the shared folder 21.

Next, the agent 20 searches for a printable printer 40 or specifies a preset default printer 40, transmits the print data to the searched or specified printer 40, and performs printing based on the print data (A10).

Next, when the printing based on the print data is completed, the agent 20 deletes the print information file 211 from the shared folder 21 (A11).

When the print information file 211 is deleted in this way, the driver 30 considers that monitoring the cloud server 50 by the agent 20 has ended (A12). Thus, monitoring the shared folder 21 by the driver 30 is also ended.

Incidentally, it is assumed that an error occurs after the agent 20 starts monitoring the cloud server 50. Such an error includes, for example, a communication error. In this case, the following problems arise.

A first problem is when the agent 20 ends monitoring the cloud server 50.

A second problem is how to notify the user viewing the screen of the second information processing apparatus 10b of error information including that an error has occurred and that monitoring the cloud server 50 has been stopped.

With respect to the first problem, in the present exemplary embodiment, the agent 20 ends monitoring the cloud server 50 when the error is not solved after retrying for a predetermined period.

For the second problem, in the present exemplary embodiment, in a case where the driver 30 detects that an error information file has been stored in the shared folder 21, the driver 30 displays error information on the screen.

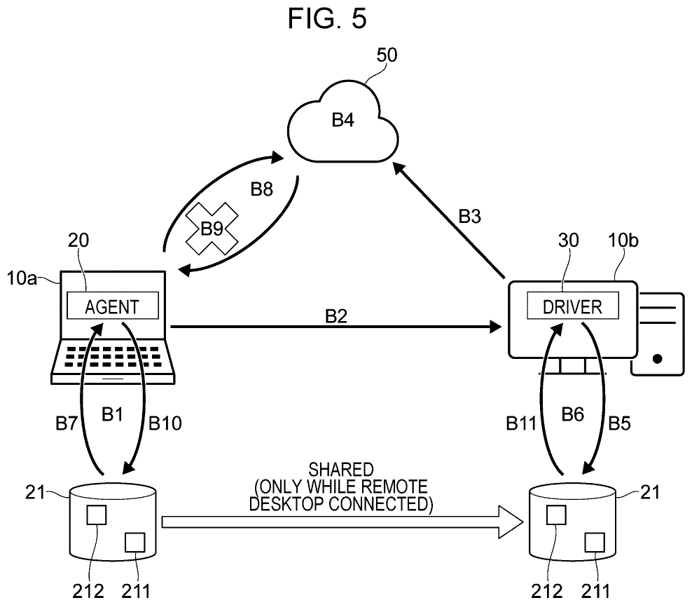

FIG. 5 is a diagram illustrating an outline of processing when such an error occurs in the printing system 1 according to the present exemplary embodiment.

Since B1 to B8 are the same as A1 to A8 of FIG. 4, description thereof will be omitted.

It is assumed that while monitoring the cloud server 50 in B8, the agent 20 detects occurrence of an error and fails to recover from the error even by retrying for a predetermined period (B9).

In this case, the agent 20 stores an error information file 212 in the shared folder 21, and stops monitoring the cloud server 50 (B10).

When the error information file 212 is stored in this way, the driver 30 considers that an error has occurred on a side of the agent 20 (B11). Thus, the user is notified the error information on the screen of the second information processing apparatus 10b displayed on the first information processing apparatus 10a. Further, monitoring the shared folder 21 by the driver 30 is also ended.

### Functional Configuration of Information Processing Apparatus

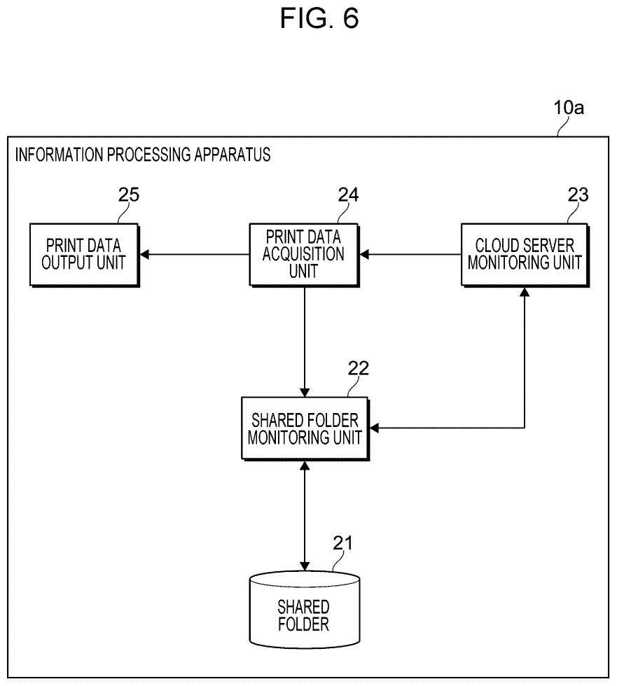

FIG. 6 is a block diagram illustrating an example of a functional configuration of the first information processing apparatus 10a in the present exemplary embodiment. As illustrated in the figure, the first information processing apparatus 10a includes the shared folder 21, a shared folder monitoring unit 22, a cloud server monitoring unit 23, a print data acquisition unit 24, and a print data output unit 25. Note that, among these functions, the functions of the shared folder monitoring unit 22, the cloud server monitoring unit 23, the print data acquisition unit 24, and the print data output unit 25 are realized by the agent 20 operating in the first information processing apparatus 10a.

As described above, the shared folder 21 is a storage area shared between the first information processing apparatus 10a and the second information processing apparatus 10b when the first information processing apparatus 10a performs the remote desktop connection to the second information processing apparatus 10b. As described above, the shared folder 21 is shared by performing setting to be shared when the first information processing apparatus 10a performs the remote desktop connection to the second information processing apparatus 10b. In the present exemplary embodiment, the shared folder 21 is used as an example of the shared area within the information processing system that is shared between the information processing system and another information processing system remotely operated by the information processing system.

When the user starts the first information processing apparatus 10a and logs in, the shared folder monitoring unit 22 starts monitoring the shared folder 21. Specifically, the shared folder monitoring unit 22 determines whether or not the print information file indicating that the second information processing apparatus 10b has registered the print data to the cloud server 50 is stored in the shared folder 21. Note that the shared folder monitoring unit 22 monitors the shared folder 21 until the user logs out from the first information processing apparatus 10a. In the present exemplary embodiment, the shared folder monitoring unit 22 performs this process as an example of monitoring the shared area. In the present exemplary embodiment, the print information file is used as an example of registration information indicating that another information processing system has registered data to the server.

In a case where the print data acquisition unit 24 acquires the print data from the cloud server 50, the shared folder monitoring unit 22 notifies the second information processing apparatus 10b, via the shared folder 21, that the print data is acquired. At that time, the shared folder monitoring unit 22 may provide a notification that the print data has been acquired from the cloud server 50 by any method, but for example, may provide a notification by a method of deleting the print information file stored in the shared folder 21. In the present exemplary embodiment, in a case where the data is acquired from the server, the shared folder monitoring unit 22 performs this process as an example of notifying another information processing system, via the shared area, that the data is acquired from the server. In the present exemplary embodiment, the shared folder monitoring unit 22 performs this process as an example of notifying another information processing system of the event of acquisition by deleting registration information stored in the shared area.

Further, when the cloud server monitoring unit 23 detects occurrence of an error and the print data acquisition unit 24 cannot acquire the print data from the cloud server 50, the shared folder monitoring unit 22 notifies the second information processing apparatus 10b, via the shared folder 21, that the print data cannot be acquired. At that time, although the shared folder monitoring unit 22 may notify that the print data cannot be acquired from the cloud server 50 by any method, for example, the shared folder monitoring unit 22 may notify that the print data cannot be acquired by a method of storing the error information file in the shared folder 21. In the present exemplary embodiment, the shared folder monitoring unit 22 performs this process as an example of notifying another information processing system, via the shared area, that the data cannot be acquired from the server in a case where the data cannot be acquired from the server. In the present exemplary embodiment, the error information file is used as an example of information indicating that the data cannot be acquired from the server. Thus, in the present exemplary embodiment, by storing such information in the shared area, the shared folder monitoring unit 22 performs this process as an example of notifying another information processing system that the data cannot be acquired.

When the shared folder monitoring unit 22 determines that the print information file is stored in the shared folder 21, the cloud server monitoring unit 23 starts monitoring the cloud server 50. Specifically, the cloud server monitoring unit 23 determines whether or not the print data associated with a user ID inputted when the user logs in to the first information processing apparatus 10a is registered in the cloud server 50. The cloud server monitoring unit 23 detects occurrence of an error while monitoring the cloud server 50. Note that the cloud server monitoring unit 23 monitors the cloud server 50 until the print data is acquired by the print data acquisition unit 24 or until the occurrence of an error is detected. In the present exemplary embodiment, in a case where the registration information is stored in the shared area, the cloud server monitoring unit 23 performs the process as an example of starting monitoring whether or not the data is registered in the server.

When the cloud server monitoring unit 23 determines that the print data associated with the user ID is registered in the cloud server 50, the print data acquisition unit 24 acquires the print data from the cloud server 50.

The print data output unit 25 outputs the print data to the printer 40 so that the printer 40 performs printing based on the print data acquired by the print data acquisition unit 24.

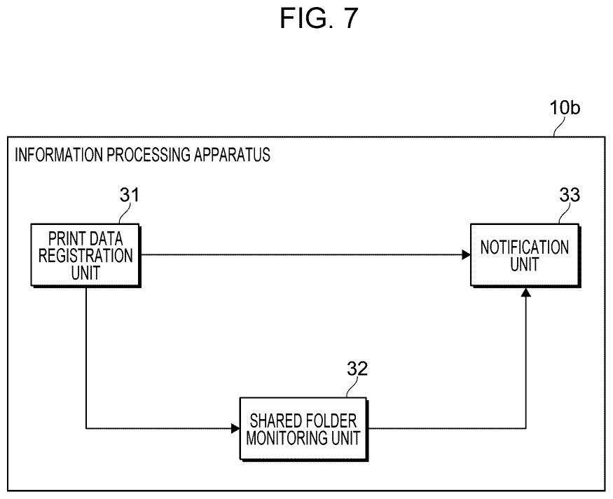

FIG. 7 is a block diagram illustrating an example of a functional configuration of the second information processing apparatus 10b according to the present exemplary embodiment. As illustrated in the figure, the second information processing apparatus 10b includes a print data registration unit 31, a shared folder monitoring unit 32, and a notification unit 33. Note that these functions are realized by operating the driver 30 in the second information processing apparatus 10b.

When the user gives an instruction to register the print data including a document to be printed and print parameters on the second information processing apparatus 10b, the print data registration unit 31 registers the print data to the cloud server 50. Specifically, the print data registration unit 31 registers the print data to the cloud server 50 associated with the user ID inputted when the user logs in to the first information processing apparatus 10a.

When the print data is successfully registered to the cloud server 50 by the print data registration unit 31, the shared folder monitoring unit 32 stores the print information file specifying the print data in the shared folder 21.

Further, when the shared folder monitoring unit 32 stores the print information file in the shared folder 21, the shared folder monitoring unit 32 starts monitoring the shared folder 21. Note that the shared folder monitoring unit 32 monitors the shared folder 21 until the print data is acquired by the print data acquisition unit 24 or until the occurrence of an error is detected. In the present exemplary embodiment, the shared folder 21 is used as an example of the shared area within another information processing system that is shared between the information processing system and the other information processing system remotely operating the information processing system. In the present exemplary embodiment, the shared folder monitoring unit 32 performs this process as an example of monitoring the shared area.

Specifically, the shared folder monitoring unit 32 detects a result of monitoring the cloud server 50 by the cloud server monitoring unit 23 from the shared folder 21. In the present exemplary embodiment, the print information file is used as an example of registration information indicating that the information processing system has registered the data in the server. Thus, in the present exemplary embodiment, the shared folder monitoring unit 32 performs this process as an example of detecting a result of monitoring, which is started by another information processing system, as to whether or not the data has been registered to the server, in a case where registration information has been stored in the shared area.

For example, when the print data acquisition unit 24 acquires the print data from the cloud server 50, the shared folder monitoring unit 32 detects that event as a result of monitoring the cloud server 50 via the shared folder 21. At that time, the shared folder monitoring unit 32 may detect that the print data has been acquired from the cloud server 50 from any state of the shared folder 21, but for example, may detect from a state in which the print information file has been deleted from the shared folder 21. In the present exemplary embodiment, the shared folder monitoring unit 32 performs this process as an example of detecting, via the shared area, that another information processing system has acquired the data from the server as a result of monitoring the server. Further, in the present exemplary embodiment, the shared folder monitoring unit 32 performs this process as an example of detecting the event of acquisition by the registration information stored in the shared area being deleted.

In a case where the cloud server monitoring unit 23 detects the occurrence of an error and the print data acquisition unit 24 cannot acquire the print data from the cloud server 50, the shared folder monitoring unit 32 detects that event as a result of monitoring the cloud server 50 via the shared folder 21. At that time, the shared folder monitoring unit 32 may detect, from any state of the shared folder 21, that the print data cannot be acquired from the cloud server 50, but may detect, for example, from a state in which the error information file is stored in the shared folder 21. In the present exemplary embodiment, the shared folder monitoring unit 32 performs this process as an example of detecting, via the shared area, that another information processing system cannot acquire the data from the server as a result of monitoring the server. In the present exemplary embodiment, the error information file is used as an example of information indicating that another information processing system cannot acquire the data from the server. Thus, in the present exemplary embodiment, by such information being stored in the shared area, the shared folder monitoring unit 32 performs this process as an example of detecting that the data cannot be acquired.

When the registration of the print data to the cloud server 50 by the print data registration unit 31 fails, the notification unit 33 notifies the user of that event by the display device 15.

When the shared folder monitoring unit 32 detects a result of monitoring the cloud server 50 by the cloud server monitoring unit 23, the notification unit 33 notifies the user of the monitoring result by the display device 15. For example, in a case where the shared folder monitoring unit 32 detects that the print data acquisition unit 24 has acquired the print data from the cloud server 50, the notification unit 33 notifies the user of that event by the display device 15. Further, when the shared folder monitoring unit 32 detects that the print data acquisition unit 24 cannot acquire the print data from the cloud server 50, the notification unit 33 notifies the user of that event by the display device 15.

### Operation of Information Processing Apparatus

First, when the user logs in to the first information processing apparatus 10a, the shared folder monitoring unit 22 in the first information processing apparatus 10a starts monitoring the shared folder 21.

Next, when the user logs in from the first information processing apparatus 10a to the second information processing apparatus 10b by the remote desktop, the shared folder 21 of the first information processing apparatus 10a is shared with the second information processing apparatus 10b after connecting the remote desktop.

In this state, it is assumed that the user gives an instruction to register the print data to the cloud server 50 on the second information processing apparatus 10b.

The subsequent operations of the first information processing apparatus 10a and the second information processing apparatus 10b will be described below.

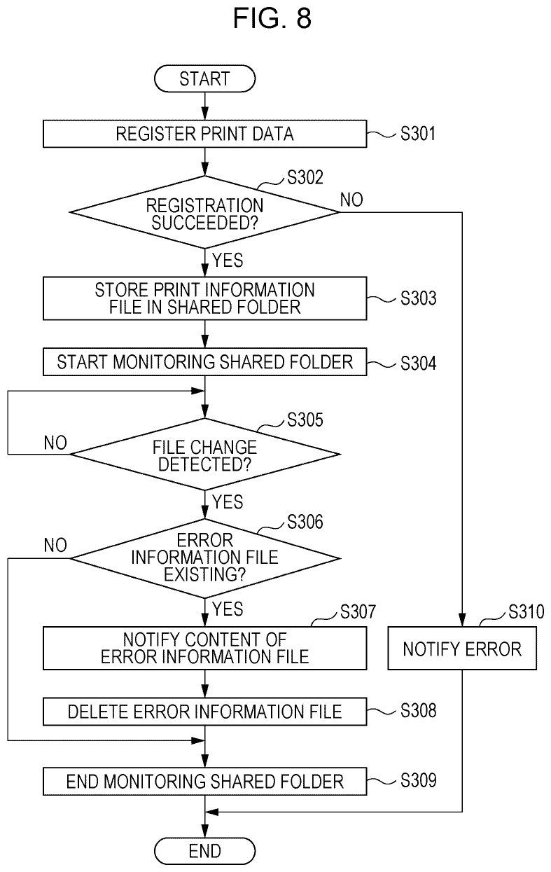

FIG. 8 is a flowchart illustrating an operation example of the second information processing apparatus 10b.

As illustrated in the figure, in the second information processing apparatus 10b, first, the print data registration unit 31 registers the print data specified by the user to the cloud server 50 associated with the user ID inputted when the user logs in to the first information processing apparatus 10a (step S301).

Next, the print data registration unit 31 determines whether or not the registration of the print data to the cloud server 50 has been successful (step S302).

As a result, when it is determined in step S302 that the print data has been successfully registered to the cloud server 50, the shared folder monitoring unit 32 stores the print information file specifying the print data in the shared folder 21 of the first information processing apparatus 10a (step S303).

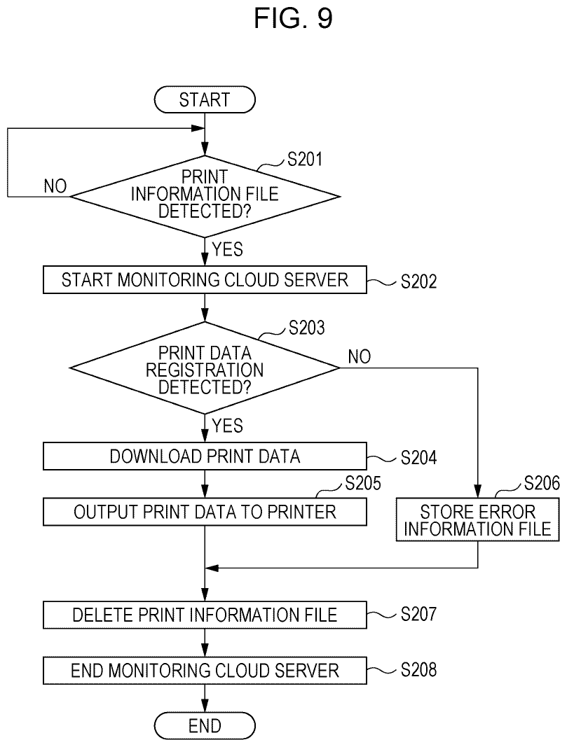

Next, the shared folder monitoring unit 32 starts monitoring the shared folder 21 (step S304). Then, the shared folder monitoring unit 32 determines whether or not a change of the file stored in the shared folder 21 has been detected (step S305). Here, the change of the file stored in the shared folder 21 may be occurred in a case where the error information file is stored in step S206 of FIG. 9 or in a case where the print information file is deleted in step S207 of FIG. 9. Therefore, the shared folder monitoring unit 32 determines whether or not the print information file is deleted from the shared folder 21 or the error information file is stored in the shared folder 21.

In step S305, when determined that the change of the file has not been detected, the shared folder monitoring unit 32 repeats the processing in step S305.

In step S305, when determined that the change of the file has been detected, the shared folder monitoring unit 32 determines whether or not the error information file is stored in the shared folder 21 (step S306).

In step S306, when determined that the error information file is stored in the shared folder 21, the notification unit 33 notifies the user of the content of the error information file by the display device 15 (step S307). Then, the shared folder monitoring unit 22 deletes the error information file from the shared folder 21 (step S308), and advances the process to step S309.

Assume that it is determined in step S306 that no error information file is stored in the shared folder 21. That is, it is determined whether or not only the deletion of the print information file from the shared folder 21 has been performed. In this case, the shared folder monitoring unit 32 advances the process to step S309 without performing the process of steps S307 to S308.

Thereafter, the shared folder monitoring unit 32 ends monitoring the shared folder 21 (step S309).

On the other hand, assume that it is determined in step S302 that the registration of the print data to the cloud server 50 has not been successful. That is, it is assumed that an error occurs in the registration of the print data to the cloud server 50 and the error is not recovered even by retrying. In this case, the notification unit 33 notifies the user of the occurrence of an error by the display device 15 (step S310).

FIG. 9 is a flowchart illustrating an operation example of the first information processing apparatus 10a.

As illustrated in the figure, in the first information processing apparatus 10a, first, the shared folder monitoring unit 22 determines whether or not the print information file is stored in the shared folder 21 (step S201).

When it is determined in step S201 that no print information file is stored in the shared folder 21, the shared folder monitoring unit 22 repeats the processing in step S201.

When it is determined in step S201 that the print information file is stored in the shared folder 21, the cloud server monitoring unit 23 starts monitoring the cloud server 50 (step S202). Next, the cloud server monitoring unit 23 determines whether or not the registration of the print data associated with the user ID inputted when the user logs in to the first information processing apparatus 10a to the cloud server 50 is detected (step S203).

When it is determined in step S203 that registration of such print data to the cloud server 50 has been detected, the print data acquisition unit 24 downloads the print data from the cloud server 50 (step S204). Then, the print data output unit 25 outputs the print data to the printer 40 so that the printer 40 performs printing based on the print data (step S205), and advances the process to step S207.

Assume that it is determined in step S203 that registration of such print data to the cloud server 50 has not been detected. That is, it is assumed that an error occurs while the cloud server monitoring unit 23 monitors the cloud server 50, the error is not recovered even by retrying, and the registration of such print data to the cloud server 50 cannot be detected. In this case, the shared folder monitoring unit 22 stores, in the shared folder 21, the error information file indicating that an error has occurred and that monitoring the cloud server 50 is to be stopped (step S206), and advances the process to step S207.

Thereafter, the shared folder monitoring unit 22 deletes the print information file from the shared folder 21 (step S207).

Then, the cloud server monitoring unit 23 ends monitoring the cloud server 50 (step S208).

Note that in the above description, after the print data is downloaded and output to the printer 40, the shared folder monitoring unit 22 deletes the print information file, and the cloud server monitoring unit 23 ends monitoring the cloud server 50, but the exemplary embodiment of the present invention is not limited thereto. After the print data is downloaded, the shared folder monitoring unit 22 may delete the print information file, the cloud server monitoring unit 23 may end monitoring the cloud server 50, and then the print data may be output to the printer 40.

Thereafter, when the user disconnects the remote desktop connection from the first information processing apparatus 10a to the second information processing apparatus 10b, the setting for sharing the shared folder 21 of the first information processing apparatus 10a becomes disabled.

Finally, when the user logs out from the first information processing apparatus 10a, the shared folder monitoring unit 22 ends monitoring the shared folder 21 in the first information processing apparatus 10a.

### Processor

In the present exemplary embodiment, the processor refers to a processor in a broad sense, and includes general-purpose processors (for example, a central processing unit (CPU), and the like), dedicated processors (for example, a graphics processing unit (GPU), an application specific integrated circuit (ASIC), a field programmable gate array (FPGA), a programmable logic device, and the like).

Further, the operation of the processor in the present exemplary embodiment may be performed not only by one processor but also by a plurality of processors existing at physically distant locations in cooperation with each other. In addition, the order of the operations of the processor is not limited to the order described in the present exemplary embodiment, and may be changed.

### Program

The processing performed by the first information processing apparatus 10a in the present exemplary embodiment is prepared as a program, for example, application software, and the like.

In this case, the program for realizing the present exemplary embodiment is regarded as the program for causing the computer to realize a function of monitoring the shared area in the computer that is shared between the computer and another computer remotely operated by the computer, and a function of starting monitoring, in a case where registration information indicating that the other computer has registered the data to the server is stored in the shared area, as to whether or not the data has been registered to the server.

Additionally, the processing performed by the second information processing apparatus 10b according to the present exemplary embodiment is also prepared as a program, for example, application software, and the like.

In this case, the program for realizing the present exemplary embodiment is regarded as the program that causes the computer to realize a function of monitoring the shared area in another computer that is shared between the computer and the other computer remotely operating the computer, and a function of detecting a result of monitoring as to whether or not data has been registered in a server, the monitoring being started by the other computer in a case where registration information indicating that the computer has registered the data in the server is stored in the shared area.

Note that the program for realizing the present exemplary embodiment can be provided not only through a communication means but also by being stored in a recording medium such as a CD-ROM.

### APPENDIX

(((1)))

An information processing system comprising:
one or more processors configured to:
   monitor a shared area within an information processing system that is shared between the information processing system and an other information processing system remotely operated by the information processing system; and
   in a case where registration information indicating that the other information processing system has registered data in a server is stored in the shared area, start monitoring whether or not the data has been registered in the server.
      (((2)))

The information processing system according to (((1))), wherein the one or more processors are configured to, in a case where the data is acquired from the server, notify the other information processing system, via the shared area, that the data has been acquired from the server.

(((3)))

The information processing system according to (((2))), wherein the one or more processors are configured to notify the other information processing system of the acquisition by deleting the registration information stored in the shared area.

(((4)))

The information processing system according to any one of (((1)) to (3))), wherein the one or more processors are configured to, in a case where the data cannot be acquired from the server, notify the other information processing system, via the shared area, that the data cannot be acquired from the server.

(((5)))

The information processing system according to (((4))), wherein the one or more processors are configured to notify the other information processing system that the data cannot be acquired, by storing information indicating that the data cannot be acquired from the server in the shared area.

(6)

An information processing system comprising:
one or more processors configured to:
   monitor a shared area in an other information processing system that is shared between the information processing system and the other information processing system remotely operating the information processing system; and
   detect a result of monitoring as to whether or not data has been registered in a server, the monitoring being started by the other information processing system in a case where registration information indicating that the information processing system has registered the data in the server is stored in the shared area.
      (((7)))

The information processing system according to (((6)), wherein the one or more processors are configured to detect, as a result of monitoring the server, via the shared area, that the other information processing system has acquired the data from the server.

(((8)))

The information processing system according to (((7))), wherein the one or more processors are configured to detect the acquisition by the registration information stored in the shared area being deleted.

(((9)))

The information processing system according to any one of (((6)) to ((8))), wherein the one or more processors are configured to detect, as a result of monitoring the server, via the shared area, that the other information processing system cannot acquire the data from the server.

(((10)))

The information processing system according to (((9))), wherein the one or more processors are configured to detect that the data cannot be acquired from the server, by information indicating that the other information processing system cannot acquire the data from the server being stored in the shared area.

(((11)))

A program causing a computer to execute a process comprising:
monitoring a shared area in the computer that is shared between the computer and an other computer remotely operated by the computer; and
in a case where registration information indicating that the other computer has registered data in a server is stored in the shared area, starting monitoring as to whether or not the data has been registered in the server.
   (((12)))

A program causing a computer to execute a process, the process comprising:
monitoring a shared area in an other computer that is shared between the computer and the other computer remotely operating the computer; and
detecting a result of monitoring as to whether or not data has been registered in a server, the monitoring being started by the other computer in a case where registration information indicating that the computer has registered the data in the server is stored in the shared area.

What is claimed is:

1. An information processing system comprising:
one or more processors configured to:
monitor a shared area within the information processing system that is shared between the information processing system and an other information processing system remotely operated by the information processing system; and
in a case where registration information indicating that the other information processing system has registered data in a server is stored in the shared area, start monitoring whether or not the data has been registered in the server.

2. The information processing system according to claim 1, wherein the one or more processors are configured to, in a case where the data is acquired from the server, notify the other information processing system, via the shared area, that the data has been acquired from the server.

3. The information processing system according to claim 2, wherein the one or more processors are configured to notify the other information processing system of the acquisition by deleting the registration information stored in the shared area.

4. The information processing system according to claim 1, wherein the one or more processors are configured to, in a case where the data cannot be acquired from the server, notify the other information processing system, via the shared area, that the data cannot be acquired from the server.

5. The information processing system according to claim 4, wherein the one or more processors are configured to notify the other information processing system that the data cannot be acquired, by storing information indicating that the data cannot be acquired from the server in the shared area.

6. An information processing system comprising:
one or more processors configured to:
monitor a shared area in an other information processing system that is shared between an information processing system and the other information processing system remotely operating the information processing system; and
detect a result of monitoring as to whether or not data has been registered in a server, the monitoring being started by the other information processing system in a case where registration information indicating that the information processing system has registered the data in the server is stored in the shared area.

7. The information processing system according to claim 6, wherein the one or more processors are configured to detect, as a result of monitoring the server, via the shared area, that the other information processing system has acquired the data from the server.

8. The information processing system according to claim 7, wherein the one or more processors are configured to detect the acquisition by the registration information stored in the shared area being deleted.

9. The information processing system according to claim 6, wherein the one or more processors are configured to detect, as a result of monitoring the server, via the shared area, that the other information processing system cannot acquire the data from the server.

10. The information processing system according to claim 9, wherein the one or more processors are configured to detect that the data cannot be acquired from the server, by information indicating that the other information processing system cannot acquire the data from the server being stored in the shared area.

11. A non-transitory computer readable medium storing a program causing a computer to execute a process comprising:
monitoring a shared area in the computer that is shared between the computer and an other computer remotely operated by the computer; and
in a case where registration information indicating that the other computer has registered data in a server is stored in the shared area, starting monitoring as to whether or not the data has been registered in the server.
